(19) United States
(12) Patent Application Publication
(10) Pub. No.: US 2025/0207018 A1
(43) Pub. Date: Jun. 26, 2025

(54) MORE EFFICIENT PHOTOLUMINESCENT MATERIAL

(71) Applicant: The Swatch Group Research and Development Ltd, Marin (CH)

(72) Inventors: Nicolas FRANÇOIS, Neuchâtel (CH); Nathalie TERES, Bôle (CH)

(73) Assignee: The Swatch Group Research and Development Ltd, Marin (CH)

(21) Appl. No.: 18/917,296

(22) Filed: Oct. 16, 2024

(30) Foreign Application Priority Data
Dec. 21, 2023 (EP) 23219372.2

(51) Int. Cl. C09K 11/06; C09K 11/59; C09K 11/64; C09K 11/77

(52) U.S. Cl. CPC C09K 11/06; C09K 11/592; C09K 11/641; C09K 11/7786; C09K 11/7792; C09K 2211/14

(57) ABSTRACT

A photoluminescent material including by weight a polymer matrix in a percentage comprised between 19.99% and 54.99%, a photoluminescent compound in a percentage comprised between 45% and 80%, porous silica in a percentage comprised between 0.01% and 1% and optionally a dye system and additives with a total percentage for the dye system and additives comprised between 0% and 15%. Also, an article made from or coated with this photoluminescent material.

### CROSS-REFERENCE TO RELATED APPLICATIONS

This application claims priority to European Patent Application No. 23219372.2 filed Dec. 21, 2023, the entire contents of which are incorporated herein by reference.

### TECHNICAL FIELD OF THE INVENTION

The invention relates to a photoluminescent material with improved luminescence performance.

### TECHNOLOGICAL BACKGROUND

Phosphorescent materials made from a mixture of transparent or translucent materials with photoluminescent pigments produced from rare earth-doped mineral oxides are already known. Examples include a mixture of borosilicates with 50% strontium aluminate doped with Europium or Dysprosium (Eu²⁺, Dy³⁺:SrAl₂O₄) or a mixture of acrylic resins with 50% strontium aluminate doped with Europium or Dysprosium. The luminous decay of these materials is initially exponential. If we start with a luminance of a few tens of Cd/m² for a material placed in the dark after saturation with light energy, the luminance after 10 minutes in the dark will be less than 1 Cd/m². Luminous decay then tends slowly towards an asymptote at a few mCd/m² which explains why these materials retain a visible luminous persistence in the dark for up to 12 hours. Good readability of diving instruments passively requires these luminescent materials, and progress in terms of luminous performance is therefore eagerly awaited.

As the phosphorescent pigment is sensitive to humidity, it is now desirable to produce photoluminescent decorations to encapsulate the pigments in a transparent material and thus produce a photoluminescent material. For aesthetic reasons, in particular daylight perception, these photoluminescent materials can also be dyed using a dye system, a mixture of pigments and additives.

It is realised that the compounds used in the photoluminescent material, including the dye pigments, have a quenching effect on the luminescent properties, the luminance of the phosphorescent materials being the result of a physico-chemical interaction between the various compounds of the photoluminescent material.

### SUMMARY OF THE INVENTION

The invention involves developing a new formulation for photoluminescent materials that limits the quenching associated with the compounds added to the formulation.

To this end, it is proposed to add a porous silica-type dopant derived from algae to the formulation. Porous silica comes from diatom skeletons. These are microalgae which are unicellular organisms with a silica skeleton. Indeed, according to the latest biological research, diatom, a single-celled algae that make up plankton, is made up of silica nanocells that are highly efficient in absorbing daylight, even in the dark depths of the oceans, so that they can photosynthesise efficiently.

According to the invention, the addition of a limited percentage of porous silica, with contents of less than or equal to one percent by mass, to the photoluminescent material allows to significantly improve the luminescence properties.

More specifically, the invention relates to an article made from a photoluminescent material including by weight a polymer matrix in a percentage comprised between 19.99% and 54.99%, a photoluminescent compound in a percentage comprised between 45% and 80%, porous silica in a percentage comprised between 0.01% and 1% and optionally a dye system and additives with a total percentage for the dye system and additives comprised between 0% and 15%.

### DETAILED DESCRIPTION OF THE INVENTION

The invention relates to a photoluminescent material including porous silica. It also relates to an article coated with or made of this photoluminescent material. The article may, for example, be a timepiece component. More specifically, it may be a component selected from the non-exhaustive list comprising a case middle, a case back, a bezel, a crown, a push-button, a bracelet link, a bracelet, a tongue buckle, a clasp, a dial, a flange, a date disc, a dial hand and a dial index.

The photoluminescent material includes (consists of) a polymer matrix, a photoluminescent compound, porous silica, and optionally a dye system and additives.

With respect to the total weight of the photoluminescent material, the porous silica is present in a percentage by weight comprised between 0.01% and 1%, preferably between 0.07% and 0.3%, more preferably between 0.09% and 0.2%. This is a porous silica derived from diatom skeletons. Typically, the average diameter of the pores may be of the order of 500 nm. It could also be a synthetic porous silica. For a synthetic silica, the pores typically have an average diameter comprised between 0.1 μm and 3 μm. The polymer matrix is present in a percentage by weight comprised between 19.99% and 54.99%, preferably between 29.93% and 49.93%, more preferably between 29.91% and 49.91%. This may include all polymers that are transparent or semi-transparent in the visible range. By way of example, it may be one or more of the following polymers: resins from the acrylic family, the polyamide family, the polyolefin family, the epoxy family, the polyurethane family, the fluoroelastomer family and silicones. The photoluminescent compound is present in a percentage by weight comprised between 45% and 80%, preferably between 50% and 70%. The luminescent compound may consist of a pigment or a pigment encapsulated in a shell. The pigment is preferably a rare earth-doped alkaline earth aluminate derivative. More specifically, the pigment can be Europium or Dysprosium doped strontium aluminate with the formula Sr(x)Al(y)O(z):Eu²⁺, Dy³⁺. In particular, this may be Sr₄Al₁₄O₂₅:Eu²⁺, Dy³⁺ or SrAl₂O₄:Eu²⁺, Dy³⁺, optionally both present in the photoluminescent compound. Advantageously, the pigments can have different particle sizes to allow optimum distribution in the volume of the pigments and avoid free spaces. The presence of different particle sizes in the volume also allows to combine small particles forming shallow surface traps responsible for high light intensity over short periods with large particles forming deeper traps responsible for light remanence over long periods. By way of example, the pigments may have a first particle size range centred on a diameter D1 comprised between 500 nm and 10 μm, ideally between 500 nm and 5 μm, and a second particle size range centred on a diameter D2 comprised between 10 μm and 500 μm, ideally between 10 μm and 20 μm, with the particle size measured by laser particle size analysis ISO 13320:2020, possibly supplemented by SEM analysis using secondary electron imaging. It should be noted that more than two particle size fractions can be sieved and then combined. For example, it is possible to have a first fraction between 500 nm and 5 μm in a weight percentage of 20%, a second fraction between 5 μm and 20 μm in a weight percentage of 60% and a third fraction between 20 μm and 50 μm in a weight percentage of 20%.

The pigments may be encapsulated in a transparent organic or mineral shell. The organic shell can typically be selected from the polymers mentioned for the polymer matrix. For a mineral shell, it may for example, be a silica shell (SiO₂) obtained, for example, by a sol-gel method. Other examples of mineral shells include zirconium oxide (ZrO₂) and aluminium oxide (Al₂O₃), etc. The photoluminescent material optionally includes, in a percentage comprised between 0% and 15%, preferably between 0% and 5%, a dye system and additives. The dye system preferably includes organic dyes which do not absorb in the emission wavelength ranges of the photoluminescent pigment. These may be pigments or fluorescent dyes whose absorption is more in the UV range and whose emission is in the visible spectrum. For example, this may be organic fluorescent pigments or dyes such as those from the brand Radiant or Aralon®. They can also be translucent pigments or dyes with low absorption in the emission wavelengths of the phosphorescent pigment. For example, this may be translucent pigments or dyes from the brand Clariant. Other additives such as metallic and pearlescent effect pigments, anti-UV additives to protect the polymer matrix, a dispersant such as silane to facilitate dispersion of the additives and a nanometric filler of the silica type to adapt the viscosity parameters of the mixture, etc. can be added.

The method consists of mixing the polymer(s) intended to form the polymer matrix with, preferably, a dispersant. This first mixture is made with the photoluminescent pigments, which may have been encapsulated beforehand. The porous silica is then added to this second mixture, along with any dye system and additives that may have been added. The mixtures can be made either from liquid resins using a speed-mixer or a paddle mixer. The resulting mixture can then be shaped by extrusion. The mixtures can also be made in a twin-screw extruder or in a high-speed mixer for the manufacture of thermoplastic mixtures and transformation into pellets, reusable for injection moulding.

Tests were carried out by adding between 0.09% and 0.2% by weight, relative to the total weight of the photoluminescent material, of porous silica to a two-component epoxy resin with an amide hardener. A filler rate of 50% of photoluminescent pigments formed from Europium and Dysprosium doped strontium aluminate, relative to the total weight of the photoluminescent material, was added.

The material was shaped by cast moulding this mixture. The person skilled in the art can easily transpose this formula to other classes of polymer materials which can be injection moulded or extruded. This formula is also easily transferable to dispersions of polymers in solvents for application by screen printing, pad printing, spraying, etc.

Luminescence properties were measured in accordance with the ISO 17514-2003 standard and an improvement of 5% to 7% was observed compared to the same composition without the addition of porous silica.

1. A photoluminescent material including by weight a polymer matrix in a percentage comprised between 19.99% and 54.99%, a photoluminescent compound in a percentage comprised between 45% and 80%, porous silica in a percentage comprised between 0.01% and 1% and a dye system and additives with a total percentage for the dye system and additives comprised between 0% and 15%.

2. The photoluminescent material according to claim 1, wherein the polymer matrix is present in a percentage comprised between 29.93% and 49.93%, the photoluminescent compound in a percentage comprised between 50% and 70%, and the porous silica in a percentage comprised between 0.07% and 0.3%.

3. The photoluminescent material according to claim 1, wherein the polymer matrix is present in a percentage comprised between 29.91% and 49.91%, the photoluminescent compound in a percentage comprised between 50% and 70%, and the porous silica in a percentage comprised between 0.09% and 0.2%.

4. The photoluminescent material according to claim 1, wherein the porous silica is derived from diatom skeletons.

5. The photoluminescent material according to claim 1, wherein the photoluminescent compound includes a pigment which is a rare earth-doped alkaline earth aluminate derivative.

6. The photoluminescent material according to claim 5, wherein the pigment is a Europium, Dysprosium doped alkaline earth aluminate derivative of formula Sr(x)Al(y)O(z):Eu²⁺, Dy³⁺.

7. The photoluminescent material according to claim 6, wherein the pigment is Sr₄Al₁₄O₂₅:Eu²⁺, Dy³⁺ and/or SrAl₂O₄:Eu²⁺, Dy³.

8. The photoluminescent material according to claim 5, wherein the photoluminescent compound consists of said pigment encapsulated in a transparent organic or mineral shell.

9. The photoluminescent material according to claim 1, wherein the polymer matrix includes one or more resins from the acrylic family, the polyamide family, the polyolefin family, the epoxy family, the polyurethane family, the fluoroelastomer family and silicones.

10. The photoluminescent material according to claim 8, wherein the transparent organic shell includes one or more resins from the acrylic family, the polyamide family, the polyolefin family, the epoxy family, the polyurethane family, the fluoroelastomer family and silicones, and in that the transparent inorganic shell includes silica.

11. The photoluminescent material according to claim 5, wherein the photoluminescent compound includes pigments of different particle sizes.

12. The photoluminescent material according to claim 11, wherein the pigments have at least a first particle size range centred on a diameter D1 comprised between 500 nm and 10 μm and a second particle size range centred on a diameter D2 comprised between 10 μm and 500 μm.

13. An article made of or coated with said photoluminescent material according to claim 1.

14. The article according to claim 13, wherein the article is a timepiece component.
